(19) United States
(12) Patent Application Publication
(10) Pub. No.: US 2016/0127691 A1
(43) Pub. Date: May 5, 2016

(54) METHOD, COMPUTER PROGRAM, AND SYSTEM FOR ADJUSTING CAMERAS

(71) Applicant: WOW Insites, LLC, Elkhorn, NE (US)

(72) Inventors: Chad Bokowski, Elkhorn, NE (US); Matthew Hovanec, Berkeley, CA (US); Jamie Bumgardner, Gretna, NE (US); Steven Kanne, Elkhorn, NE (US)

(73) Assignee: WOW Insites LLP, Elkhorn, NE (US)

(21) Appl. No.: 14/612,341

(22) Filed: Feb. 3, 2015

Related U.S. Application Data
(60) Provisional application No. 62/075,119, filed on Nov. 4, 2014.

(51) Int. Cl. H04N 7/18; H04N 5/232; G08B 13/196

(52) U.S. Cl. CPC H04N 7/181; G08B 13/19656; H04N 5/23212

(57) ABSTRACT

A system, method, and computer program for remotely viewing video or still images from one or more cameras on a customer network, providing real-time feedback on focus adjustments made by an operator. The system may include a security bridge device plugged into the customer network and a portable electronic device remotely located from the security bridge device. The security bridge device may auto-negotiate network settings with the customer network, automatically discover the cameras on the customer network, automatically/manually address and configure the cameras, and/or automatically/manually determine a best path for transmitting the video or still images. The portable electronic device may receive and display the video or still images from the cameras transmitted by the security bridge device via the determined best path. This allows the operator to focus one of the cameras while viewing the real-time video or still images therefrom.

### RELATED APPLICATIONS

This application claims priority benefit of a provisional application entitled, “Method, Computer Program, and System for Adjusting Cameras,” Ser. No. 62/075,119, filed Nov. 4, 2014 and incorporated by reference herein in its entirety.

### BACKGROUND

Security cameras are frequently used for remote monitoring of people, places, or things. Video and/or photos obtained by the security cameras may be stored and accessed locally on the security camera and/or may be controlled and accessed remotely by an operator with monitoring responsibilities. To focus or otherwise adjust the security cameras, two operators are traditionally required—one at a client work station viewing the transmitted video or photo feed, and one physically located at the security camera to manually focus the security camera. This can be a time-consuming and labor-intensive process. The operators typically communicate by phone, with the operator at the client work station describing adjustments that must be made to bring the video or photos into focus. Both operators must therefore understand and use the same terminology. Furthermore, latency in the network between the security camera and the operator at the client work station can add to the difficulties of focusing the security camera in this traditional manner.

Another method of focusing or otherwise adjusting security cameras involves a single operator and the use of a Power over Ethernet (PoE) break-out device used at the security camera location. The PoE break-out device may allow the security camera to maintain power while splitting out the data to a laptop being used by the operator focusing the camera. Specifically, the PoE break-out device may split the twisted pair cable from the PoE of the security camera's data cables. However, this method is also time-consuming, as it requires unplugging and subsequently rebooting the security camera to focus it. Rebooting of the security camera can take a considerable amount of time. In some instances, the operator must understand IP masking in order to connect the security camera in this manner. This method also requires that the operator carry a laptop computer, which can be cumbersome, especially if the operator must climb a ladder to reach the security camera.

Many security cameras also have an inconvenient twisted pair cable connection location, complicating connection of the PoE break-out device and potentially causing undesired movement of the security camera when disconnecting the PoE break-out device. In a dome camera, removal and subsequent replacement of the dome is not only time consuming, but may also knock the security camera out of focus when placed back onto the security camera.

### SUMMARY OF THE INVENTION

Embodiments of the present invention solve the above-mentioned problems and provide a distinct advance in the art of remote camera control. Specifically, embodiments of the present invention may provide a method, computer program, and system for adjusting cameras through a security bridge device plugged into a customer network and a software application on a portable electronic device.

One embodiment of the invention provides a method for remotely viewing and substantially simultaneously adjusting camera settings. The method may include the steps of plugging a security bridge device into a customer network and receiving video or still images from cameras of the customer network on a portable electronic device via the security bridge device. That is, the portable electronic device may wirelessly communicate with the security bridge device, which may communicate directly with the customer network and its cameras. The method may also include the steps of viewing the video or still images on a display of the portable electronic device while substantially simultaneously adjusting the focus of the camera or cameras based on the video or still images being viewed. This provides the operator with real-time feedback on how manual focusing adjustments are affecting the video or still images

Another embodiment of the invention includes a system for remotely viewing video or still images from cameras in a customer network, providing real-time feedback on focus adjustments made by an operator. The system may include a security bridge device and a portable electronic device remotely located from the security bridge device. The security bridge device may physically and communicably couple to the customer network and may communicate with the portable electronic device using wireless communication and/or an internet connection. The portable electronic device may have a display, a user interface, and a processor. The processor may receive and display the video or still images on the display from the cameras as transmitted by the security bridge device via the internet or wireless transmission.

Yet another embodiment of the invention provides a security bridge device allowing remote access to video or still images from cameras on a portable electronic device. The security bridge device may include a port or plug, a processor communicably coupled to the port or plug, and a non-transitory computer readable medium communicably coupled with the processor. The port or plug may physically and communicably couple with a customer network including the cameras. The non-transitory computer-readable medium may have a computer program stored thereon that is executable by the processor. The computer program may include a code segment for auto-negotiating network settings with the customer network to allow communication between the cameras and the portable electronic device, as well as a code segment for basic addressing and configuration of the cameras. The computer program may also include a code segment for automatically determining a best path for transmitting the video or still images, and a code segment for transmitting the video or still images from the cameras to the portable electronic device or an internet-accessible database via the internet or wireless transmission, based on the determined best path.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic diagram of a camera system connected to a viewing system constructed in accordance with various embodiments of the present invention;

FIG. 2 is a block diagram of the viewing system of FIG. 1 communicably coupled to elements of the camera system;

FIG. 3 is a flow diagram of steps of a method for remotely viewing and adjusting camera settings in accordance with various embodiments of the present invention;

FIG. 4 shows a portable electronic device of the viewing system of FIG. 1, illustrating a first menu displayed thereon;

FIG. 5 shows the portable electronic device of FIG. 4, illustrating a floor plan with graphic indicators of camera locations;

FIG. 6 shows the portable electronic device of FIG. 4, illustrating a second menu displayed thereon listing each of the cameras in a customer network; and

FIG. 7 shows the portable electronic device of FIG. 4, illustrating video displayed thereon as received from a camera of the camera system.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

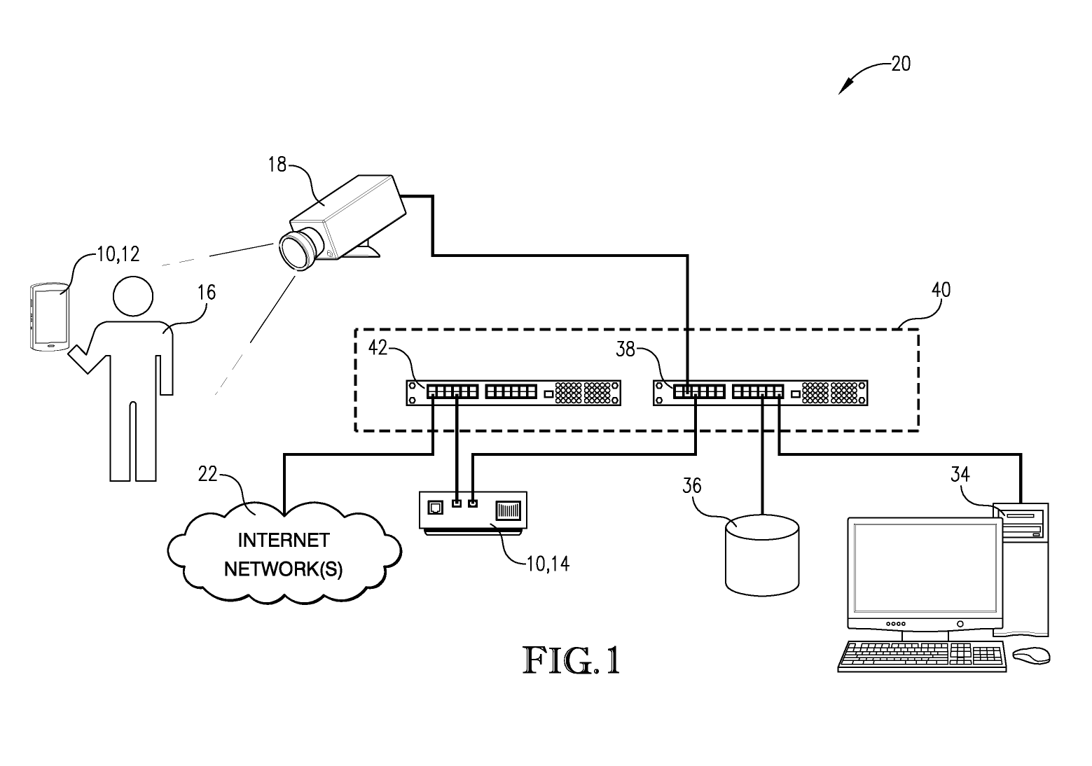

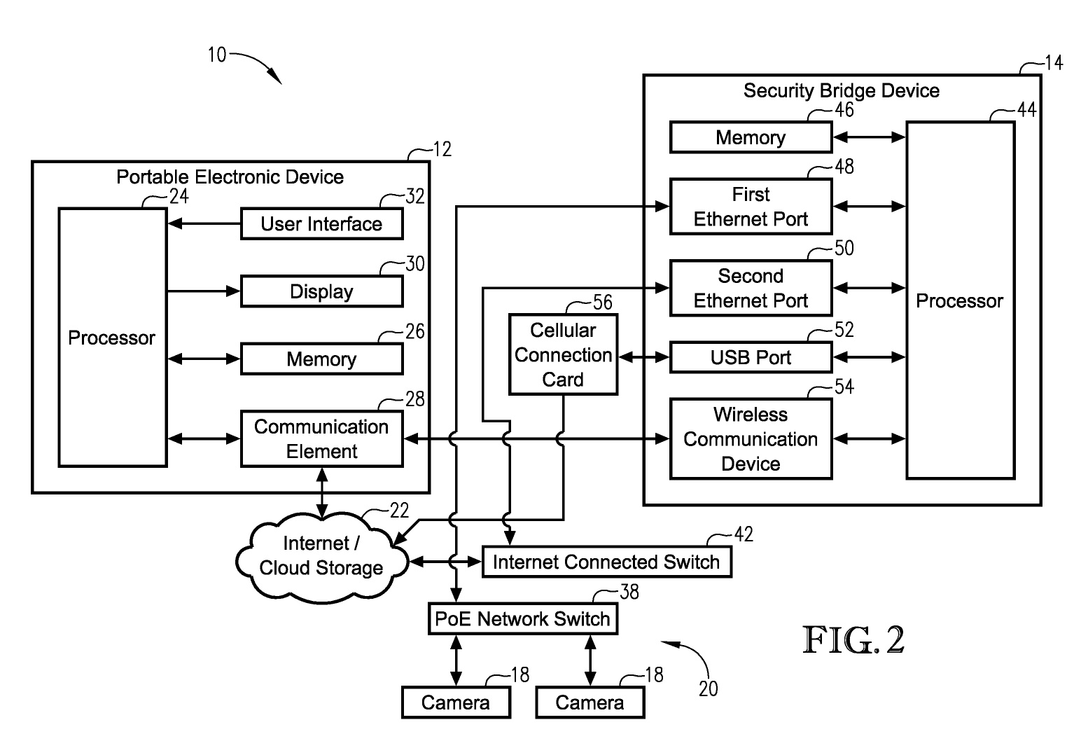

Embodiments of the present invention relate to cameras used for security, monitoring, and other purposes and provide a software application for mobile phones or other portable electronic devices to more efficiently and successfully focus and/or otherwise adjust, position, or manipulate one or more cameras. Specifically, as illustrated in FIGS. 1 and 2, embodiments of the invention relate to a viewing system 10 comprising a portable electronic device 12 and a security bridge device 14. The viewing system 10 may be used by an operator 16 to assist in focusing and/or otherwise adjusting, positioning, and/or manipulating one or more cameras 18 of a camera system 20 via a communications network 22, such as the internet and/or other communications networks.

The cameras 18 may be any camera known in the art. For example, the cameras 18 may include security cameras such as infrared (IR) security cameras, dome cameras, pro box cameras, pan tilt zoom cameras, hidden cameras, and the like. The cameras 18 may be configured for remote zoom operations and/or may require manual zooming and adjustment by the operator 16 of the portable electronic device 12, as later described herein. The cameras 18 may be configured for obtaining color or black and white still images and/or video images and may comprise any digital camera technology known in the art. The cameras 18 may be configured to send and receive information via wired or wireless communication devices. For example, the cameras 18 may send and receive information, video, and/or photos via twisted pair cables, such as CATx cables or other various Ethernet cabling.

The camera system 20 may include the cameras 18, a client workstation 34, a database 36 or other data storage device, and a customer network 40, which may include a Power over Ethernet (PoE) network switch 38 and/or an internet connected switch 42. These components of the camera system 20 may communicate with the portable electronic device 12 via the communications network 22 and the security bridge device 14. In some embodiments of the invention, the client workstation 34, the database 36, the internet connected switch 42, and/or the PoE network switch 38 may be omitted without departing from the scope of the invention.

The client workstation 34 may include any computer or server, such as a desktop computer, a laptop computer, a tablet, a mobile phone, or any other computing device having a data processor and computer-readable memory. In some embodiments of the invention, the computer-readable memory may be located remotely from the processor of the client workstation 34 and/or may be the database 36 described herein. The client workstation 34 may also comprise a display, such as a computer monitor, and a user interface, such as a keyboard, mouse, touch screen, or the like for allowing an operator thereof to send and receive information to and from the cameras 18. However, the client workstation 34 may be omitted without departing from the scope of the invention.

In some embodiments of the invention, the client workstation 34 may further include and/or be communicably coupled with one or more servers (not shown) running Windows; LAMP (Linux, Apache HTTP server, MySQL, and PHP/Perl/Python); Java; AJAX; NT; Novel Netware; Unix; or any other software system. The camera system 20 may include or have access to computer memory and other hardware and software for receiving, storing, accessing, and transmitting information. The camera system 20 may also include conventional web hosting operating software, searching algorithms, an internet connection, and may be assigned a URL and corresponding domain name so that it can be accessed via the internet in a conventional manner.

The database 36 may be communicably coupled with the client workstation 34 and/or the PoE network switch 38. The database 36 may be a video management system (VMS) database or any computer-readable medium known in the art. As used herein, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The database 36 may be any computer-readable medium, as defined above, and may store computer code, code segments, instructions, variables, specifications, graphics, video, still photos, and related data therein. Specifically, the database 36 may store

The PoE network switch 38 may be a private PoE security switch or any PoE network switch known in the art. The PoE network switch 38 may pass electrical power along with data on twisted pair cabling, allowing a single cable to provide both data connection and electrical power to devices such as wireless access points. The PoE network switch 38 may also pass electrical power along with data on twisted pair cabling to the cameras 18 described herein. However, the PoE network switch 38 may be replaced with other network switches without departing from the scope of the invention.

The customer network 40 may be any internal or local network connecting the cameras 18 with other components of the camera system 20, and may include, for example, servers, routers, switches, twisted pair cables, and the like. For example, the customer network may include the PoE network switch 38 and/or the internet connected switch 42. The customer network 40 is illustrated in FIG. 1 as communicably coupling the camera 18 with the PoE network switch 38, however, multiple cameras 18 may be communicably coupled with the PoE network switch 38, as illustrated in FIG. 2, or other components of the camera system 20 via the customer network 40 without departing from the scope of the invention.

In some embodiments of the invention, the customer network 40 may include a central server. The central server may network one or more of the cameras 18 together with other elements of the camera system 20. The central server may include conventional web hosting operating software, searching algorithms, an internet connection, and may be assigned a URL and corresponding domain name so that it can be accessed via the internet.

The internet connected switch 42 may be any internet connection switch known in the art for coupling the other components of the camera system 20 with the portable electronic device 12 via the communications network 22 and/or the security bridge device 14, as later described herein. For example, the internet connected switch 42 may communicably couple, either directly or via the security bridging device 14, with the PoE network switch 38 to exchange information. The internet connected switch 42 may likewise exchange information with servers via the internet of other communications network 22, which exchanges information with the portable electronic device 12.

The portable electronic device 12 may include one or more portable electronic devices including any of smart phones, laptop computers, tablet computers, mobile phones, notebook computers, palmtop computers, personal digital assistants (PDAs), or similar devices. Additionally or alternatively, the portable electronic device 12 may comprise workstation computers, desktop computers, file servers, application servers, database servers, and the like. Typically, as illustrated in FIG. 2, the portable electronic device 12 may include a processor 24, a memory element 26, a communication element 28, a display 30, and a user interface 32.

The processor 24 may include microprocessors, microcontrollers, digital signal processors (DSPs), field-programmable gate arrays (FPGAs), analog and/or digital application-specific integrated circuits (ASICs), and the like, or combinations thereof. The processor 24 may generally execute, process, or run instructions, code, software, firmware, programs, applications, apps, services, daemons, or the like, or may step through states of a finite-state machine.

The memory element 26 may include data storage components such as read-only memory (ROM), programmable ROM, erasable programmable ROM, random-access memory (RAM), hard disks, floppy disks, optical disks, flash memory, thumb drives, Universal Serial Bus (USB) drives, and the like, or combinations thereof. The memory element 26 may include, or may constitute, a “computer-readable medium,” as later described herein. The memory element 26 may store instructions, code, software, firmware, programs, applications, apps, services, daemons, or the like that are executed by the processing element. The memory element 26 may also store settings, data, camera specifications, databases, screenshots of camera views for customer records, and the like. The processor 24 may be in communication with the memory element 26 through address busses, data busses, control lines, and the like.

In some embodiments of the invention, the memory element 26 of the portable electronic device 12 may further include external storage, such as an external database, server, cloud storage, or the like accessible by the processing element of the portable electronic device, but not physically housed therewith. For example, the portable electronic device 12 may be configured to capture screenshots of camera views for customer records, and transmit these screenshots to external storage devices which may be accessible by the operator 16 or others via the internet.

The processor 24 and the memory element 26 of the portable electronic device 12 may be configured to separate and/or cooperatively store, access, and/or execute one or more computer programs, also referred to herein as software, software applications, mobile applications, and software apps. Specifically, aspects of the invention may be implemented with one or more computer programs stored in or on computer-readable medium residing on or accessible by the portable electronic device 12, other portable electronic devices, and/or various components of the camera system 20, as described below. The computer programs may comprise listings of executable instructions for implementing logical functions in the portable electronic device 12 and can be embodied in any non-transitory computer-readable medium, such as the memory element 26 of the portable electronic device 12, for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The portable electronic device 12 may be configured for executing an application and communicating through the communication network 22 with the camera system 20 and its cameras 18. The portable electronic device 12 may include or be configured to access an internet browser and a conventional internet connection such as a wireless broadband connection, DSL converter, or ISDN converter so that it can exchange data with the camera system 20 via the communications network 22.

The communication element 28 may permit communication between the processor 24 and the camera system 20 and/or its cameras 18. The communication element 28 may comprise wireless communication devices such as receivers, transmitters, transceivers, antenna, and the like. However, in some alternative embodiments of the invention, the communication element 28 may communicate through cables or wires. Wireless communication as described herein may include radio frequency (RF) communication including cellular or mobile phone standards such as 3G or 4G, Institute of Electrical and Electronics Engineers (IEEE) 802.11 standards for wireless networking, Bluetooth™ standards, Wi-Fi, and the like. Accordingly, the portable electronic device 12 may include one or more broadband wireless transmitters and receivers and/or one or more transmitter and receiver circuits.

The display 30 may be configured to display information, graphics, graphical user interfaces, video, and still images to the operator 16. In some embodiments of the invention, the display 30 may comprise an LCD (Liquid Crystal Display) display, a TFT (Thin Film Transistor) LCD display, an LEP (Light Emitting Polymer) or PLED (Polymer Light Emitting Diode) display, and so forth. The display 30 may be backlit via a backlight such that it may be viewed in the dark or other low-light environments. In some embodiments of the invention, the display 30 may not be physically integrated into the portable electronic device 12 and may instead be communicably connected to the processor 24 externally using Universal Serial Bus (USB), Ethernet, serial connections, twisted pair cables, and so forth. In some embodiments of the invention, the display 30 may be provided with a touch screen to receive input (e.g., data, commands, etc.) from the operator 16. For example, the operator 16 may operate the portable electronic device 12 by touching the touch screen and/or by performing gestures on the screen. In some embodiments, the touch screen may be a capacitive touch screen, a resistive touch screen, an infrared touch screen, combinations thereof, and the like.

The user interface 32 may be communicably coupled with the processor 24 and may be configured for operation by the operator 16 to make selections or input data for manipulation of the video or still images from the cameras 18 and/or the camera settings, such as zoom, position, and the like, as later described herein. The user interface 32 may comprise one or more functionable inputs such as buttons, switches, scroll wheels, keyboards, touch screen associated with the display, voice recognition elements such as a microphone, pointing devices such as mice, touchpads, tracking balls, styluses, a camera such as a digital or film still or video camera, combinations thereof, etc. The user interface 32 may also include an optional speaker for providing audible instructions and feedback.

The security bridge device 14 may be configured to communicably couple to the internet connected switch 42 and/or the PoE network switch 38 via communication cables, communication ports, and the like. As illustrated in FIG. 2, the security bridge device 14 may comprise a processor 44, memory 46, and/or various connection or communication ports 48,50,52, and may be configured to determine a best path possible for the portable electronic device 12 to communicate with the customer network 40 and/or the cameras 18. The security bridge device 14 may also comprise a wireless communications device 54, such as a transmitter, receiver, or transceiver configured to allow wireless communication between the portable communication device 12 and the processor 44 and/or memory 46 of the security bridge device 14 through Wi-Fi, Bluetooth™, or over a cell data connection such as a 3G or 4G cellular network.

In some embodiments of the invention, the security bridge device 14 may have a first, second, and third communication port 48,50,52. For example, the security bridge device 14 may comprise a first Ethernet port 48, a second Ethernet port 50, and/or a USB port 52. The first Ethernet port 48 may physically and communicably couple the security bridge device 14 to the PoE network switch 38 and/or the internet connected switch 42. If the camera system 20 has internet connectivity, the security bridge device 14 may establish a secure tunnel or virtual private network (VPN) connection with a remote server (e.g., a cloud storage device), thereby allowing the operator 16 of the portable electronic device 12 to securely access and view images and/or video transmitted by the cameras 18. The secure tunnel or VPN connection may include, for example, IPSec, OpenVPN, a SSH tunnel/stunnel, or the like. In some embodiments of the invention, the remote server may buffer the video and/or still images over a simple https://connection.

If the camera system 20 does not have direct access to the internet, the second Ethernet port 50 may connect to a network that does have internet access (e.g., connecting to the internet connected switch 42), creating a bridge between the two networks for the purposes of viewing the cameras 18. If a second network is not available for internet connectivity, the USB port 52 may be used for insertion of an internet-connected device 56 such as an air card. For example, a 3G or 4G air card may be connected to the USB port 52 of the security bridge device 14, providing alternate internet connectivity if a direct internet connection is not available.

The security bridge device 14 may also be configured and/or programmed to automatically discover the cameras 18 in the system 10, to automatically negotiate network settings between components of the system 10, and/or to assign IP addresses to any of the cameras 18 if Dynamic Host Configuration Protocol (DHCP) is not available. The security bridge device 14 may be configured to allow manual or automatic basic addressing and configuration of the cameras 18. The security bridge device 14 may be configured to receive signals from the portable electronic device 12 commanding remote motorized zoom and/or remote focus settings for cameras with such capabilities, and may be configured to output to the portable electronic device 12 pixel-level zoom images or video for focusing with high megapixel cameras.

The communications network 22 may generally allow communication between the portable electronic device 12 and the camera system 20 and its cameras 18. The communications network 22 may include the internet or any other communications network such as local area networks, metro area networks, wide area networks, cloud networks, the internet, an intranet, or the like, or combinations thereof. The communications network 22 may include or be in communication with a wireless network capable of supporting wireless communications such as the wireless networks operated by AT&T, Verizon, or Sprint. The wireless network may include conventional switching and routing equipment such as switches, routers, hubs, access points, and the like. The communications network 22 and wireless network may also be combined or implemented with several different networks. The portable electronic device 12 and the camera system 20 may connect to the communication network 18 either through wires, such as electrical cables or fiber optic cables, or wirelessly through known RF standards as discussed above.

The components of the viewing system 10 described herein are merely examples of equipment that may be used to implement embodiments of the present invention and may be replaced with other equipment without departing from the scope of the present invention. Some of the illustrated components of the viewing system 10 may also be combined or omitted.

In use, the viewing system 10 described above may be used to allow a single operator to easily view video or still images being transmitted in real-time by the cameras 18 and substantially simultaneously adjust focus of the cameras 18 based on the video or still images viewed. This provides the operator 16 with real-time feedback on how manual focusing adjustments are affecting the video or still images. The security bridge device 14 is plugged into the camera system 20 and may automatically discover the cameras 18 on the customer network 40 and automatically negotiate network settings such that the portable electronic device 12 can communicate with the cameras 18 via the security bridge device 14. A computer program, such as a mobile application on the portable electronic device 12, may be configured to connect the portable electronic device 12 to one or more of the cameras 18 via the security bridge device 14. The portable electronic device 12 may receive the video or still images directly from the security bridge device 14 using wireless communication such as Wi-Fi or Bluetooth™, or may receive the video or still images over the internet (e.g., via cloud storage or the like). The security bridge device 14 and/or the portable electronic device 12 may also provide pixel-level zoom of received video or still images for focusing of high megapixel cameras and may capture and/or store screenshots of selected camera views for customer records.

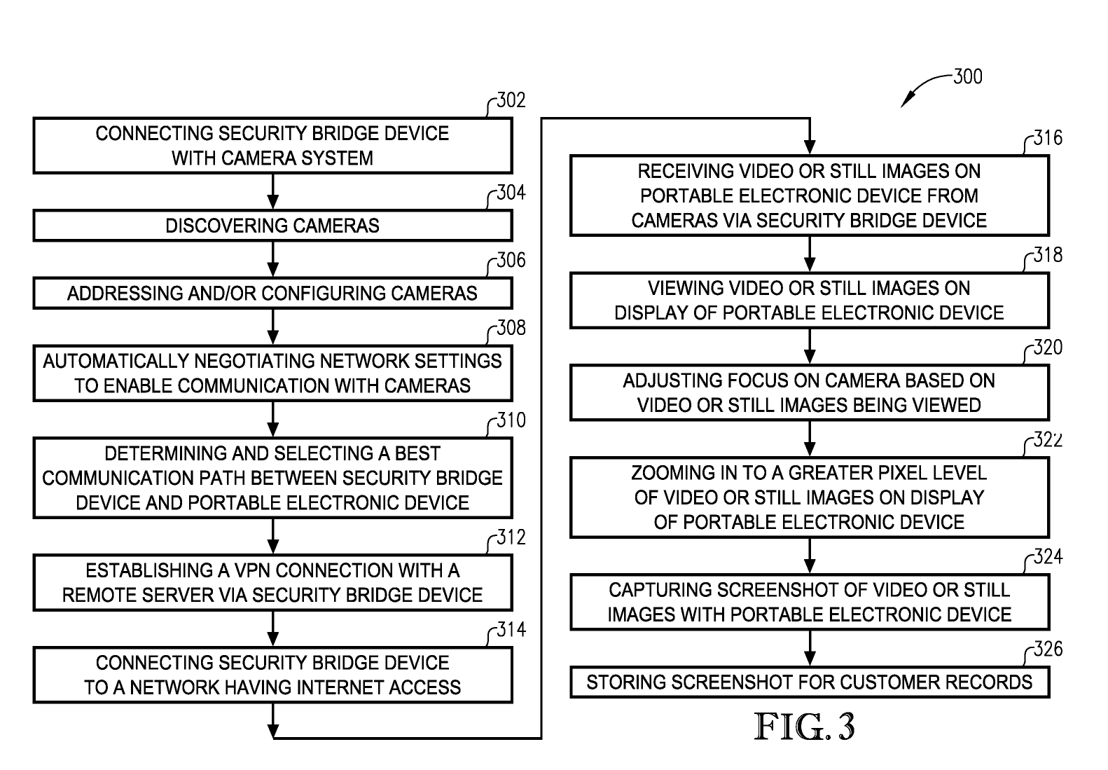

FIG. 3 illustrates steps in a method 300 for remotely viewing and adjusting camera settings, in accordance with various embodiments of the present invention. The steps of the method 300 may be performed in the order as shown in FIG. 3, or they may be performed in a different order. Furthermore, some steps may be performed concurrently as opposed to sequentially. In addition, some steps may not be performed. Some of the steps may represent code segments or executable instructions of the computer program or applications described above.

The method 300 may include a step of connecting the security bridge device 14 with the camera system 20, as depicted in block 302. In some embodiments of the invention, the security bridge device 14 may be communicably coupled with the PoE network switch 38, the internet connected switch 42, and/or other components of the customer network 40 at a centralized closet, eliminating the need to unplug anything at the cameras 18. For example, the security bridge device 14 may be physically and/or communicably coupled with a server or similar device of the customer network 40 via communication cables and/or buses. The security bridge device 14 may also be powered by the PoE network switch 38, other PoE-capable devices, or auxiliary power, which may include battery power, a wall outlet, or any other external power source.

The method 300 may further comprise the steps of discovering the cameras 18, as depicted in block 304, and addressing and/or configuring the one or more cameras, as depicted in block 306. Discovering the cameras 18 may be performed manually and/or automatically. For example, if camera IP addresses are known, they may be typed or otherwise entered by the operator 16 into the portable electronic device 12, which may transmit this information to the security bridge device 14. If Dynamic Host Configuration Protocol (DHCP) or the like for automatic discovery of the cameras is not available on the customer network 40, step 306 may include automatically assigning Internet Protocol (IP) addresses in the customer network 40 or the camera system 20.

The method 300 may comprise a step of automatically negotiating network settings to enable communication with the cameras 18, as depicted in block 308. This automatic negotiation (also referred to as auto-negotiation herein) may be defined as an Ethernet procedure by which two connected devices choose common transmission parameters, such as speed, duplex mode, and flow control. Specifically, the connected devices (i.e., the security bridge device 14 and elements of the remote computing system 16) may first share their capabilities regarding these parameters and then choose the highest performance transmission mode they both support. This step may be performed automatically by the security bridge device 14, such that the operator 16 does not need to perform any complicated or time-consuming network configuration steps manually. This auto-negotiation step allows the security bridge device 14 to communicate with a range of networks and cameras of varying configurations and capabilities.

Next, the method 300 may include a step of determining and selecting a communication path between the security bridge device 14 and the portable electronic device 12, as illustrated in block 310. This step may be carried out by the operator 16 and/or automatically by the security bridge device 14. In general, step 308 comprises the security bridge device 14 automatically making itself available to the portable electronic device 12 and computer programs thereof using the best path possible.

If the camera system 20 has internet connectivity, the method may include a step of the security bridge device 14 establishing a secure tunnel or VPN connection with a remote server, such as a web server, cloud storage device, or the like, as depicted in block 312. This step allows the operator 16 of the portable electronic device 12 to securely access and view images and/or video transmitted by the cameras 18. If the camera system 20 does not have direct access to the internet, the method 300 may include a step of the security bridge device 14 connecting to a network that does have internet access, creating a bridge between the two networks, as depicted in block 314, for the purposes of viewing the cameras 18. If a second network is not available for the internet, the USB port 52 or the like on the security bridge device 14 may be used. For example, the internet-connected device 56, such as a cellular connection card or an air card (e.g., a 3G or 4G air card), may be connected to the USB port 52 of the security bridge device 14, providing alternate internet connectivity if a direct internet connection is not available.

Next, the method 300 may include a step of receiving on the portable electronic device video or still images from at least one of the cameras 18 via the security bridge device 14, as depicted in block 316. That is, the security bridge device 14 transmits the video or still images using the communication path determined in step 310. Thus, the video or still images are received either from an internet or data connection via cloud storage or the like, or the video or still images are received via direct wireless communication with the security bridge device 14 via Wi-Fi or the like.

The method 300 may then include the steps of viewing the video or still images on the display 30 of the portable electronic device, as depicted in block 318, and substantially simultaneously adjusting focus on the camera or cameras 18 based on the video or still images being viewed, as depicted in block 320. This method provides real-time feedback to the operator 16, who may view live video or still images being captured by the cameras 18 during and after each focusing adjustment. Note that the adjusting focus step 320 may be performed manually by the operator 16 viewing the video or still images on the display 30 of the portable electronic device 12. However, in other embodiments of the invention, the operator 16 may make remote focusing adjustments using a remote control (e.g., a mobile phone application or a stand-alone remote control) and automated and/or electromechanical actuators of the cameras 18 without departing from the scope of the invention. Furthermore, note that the term “substantially simultaneously,” as used herein, may refer to an operator glancing at the display 30, glancing back at the camera 18 while focusing it, then glancing back at the display 30 to see what affect the focusing has had on the video or still images therefrom. For example, this means that the operator can view the video or still images from the camera 14 while on a ladder to remove a dome and/or manually adjust the focus of one of the cameras 14.

Additionally or alternatively, prior to the step of adjusting the focus, the operator 16 may manually or remotely adjust a zoom level of the cameras 18. For example, the portable electronic device 12 may be configured to receive zoom commands from the operator 16 via the user interface 32, and to transmit the zoom commands to the security bridge device 14. The security bridge device 14 may then communicate the zoom commands to automated and/or electromechanical actuators of the cameras 18, thereby remotely adjusting zoom levels of the cameras 18.

In some embodiments of the invention, the method 300 may further include the step of digitally zooming into a greater pixel level while viewing the video or still images on the display 30 of the portable electronic device 12, as depicted in block 322. Pixel-level may be performed by the portable electronic device 14, affecting the image displayed without affecting the zoom levels on the cameras 18 themselves. The portable electronic device 12 and/or the security bridge device 14 may allow for pixel-level zoom to facilitate accurate focusing of the cameras 18. In some embodiments of the invention, zooming down to a 1:1 pixel level or slightly greater may be required for dense megapixel cameras that may be difficult to focus.

The method 300 may also include the steps of capturing and storing a screenshot of the video or still images with the portable electronic device for customer records, as depicted in blocks 324 and 326. These images may be stored on the memory element 26 or on external memory, cloud storage, or the like, and may be accessed by the portable electronic device 12 or other internet-accessible computing devices.

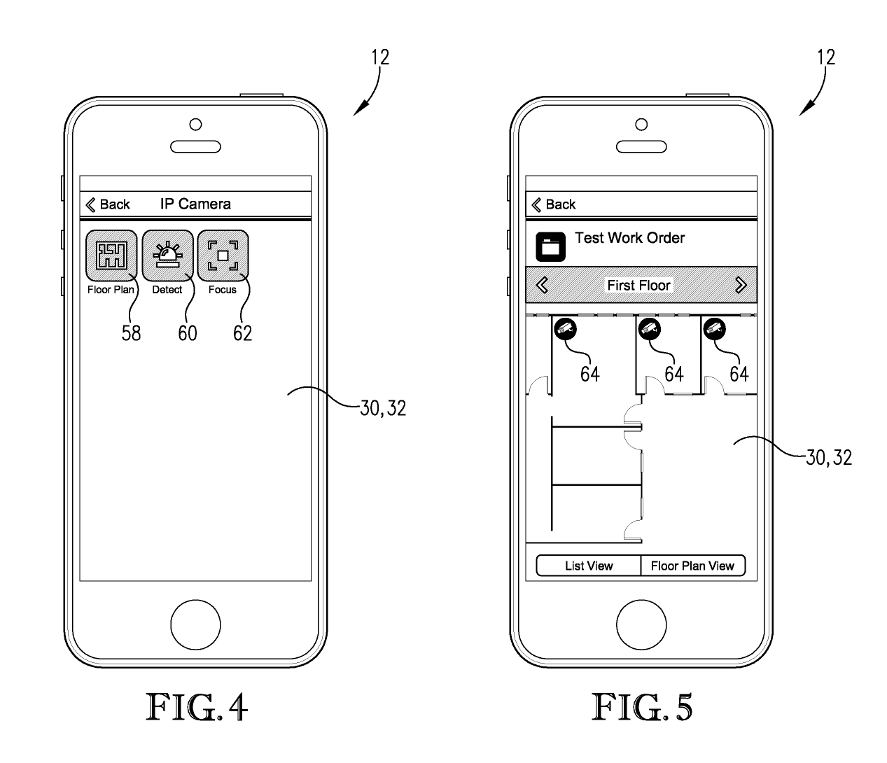

Some of the steps described above, such as steps 316, 318, 322, 324, and 326, may be carried out by executing a computer program or application located on or accessible by the portable electronic device 12. Using this computer program or app, the operator 16 may input data such as text manually via the user interface 32 and/or select one or more icons or menu options displayed on the display 30 via the user interface 32, as illustrated in FIGS. 4-7.

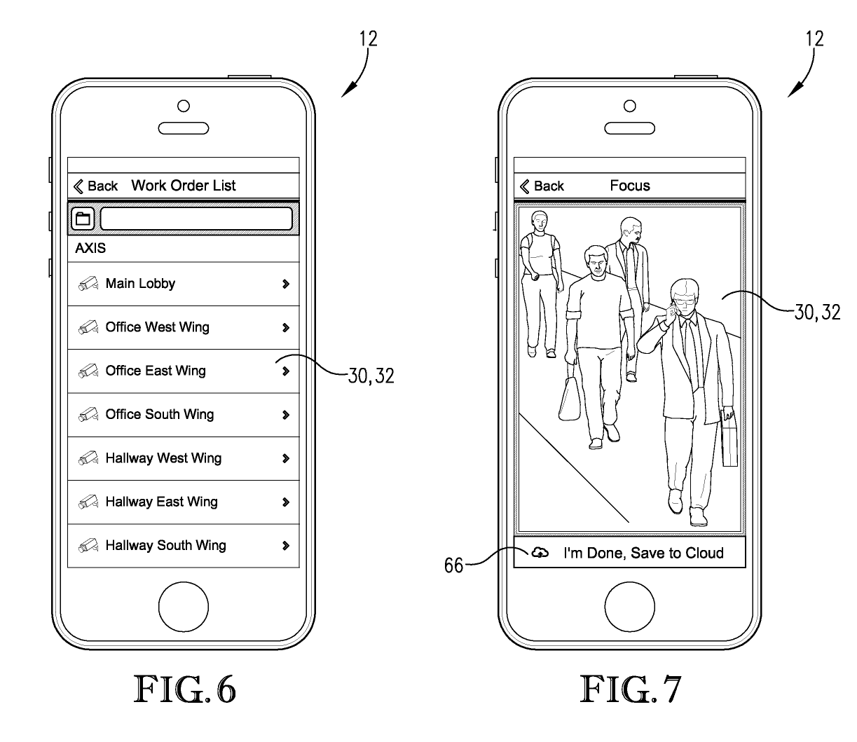

For example, as illustrated in FIG. 4, the operator 16 may choose between viewing a floor plan icon 58, a detect icon 60, and a focus icon 62. Selecting the floor plan icon 58 may provide a graphical illustration of a floor plan on the display 30, with graphical indicators 64 of locations of various cameras, as illustrated in FIG. 5. In some embodiments of the invention, graphical indicators 64 of the cameras 18 may be selectable by the operator 16 to view video and/or still images from that camera 18, viewing a list of detected cameras, and viewing a particular video stream or still images from one or more of the cameras 18. Additionally or alternatively, the various cameras 18 illustrated on the floor plan may be provided as a list, as illustrated in FIG. 6.

The detect icon 60 may be used to send signals to the security bridge device 14 commanding detection of cameras by automatic discovery, when available, or by the operator 16 manually entering an IP address of one or more of the cameras 18 via the user interface 32. If automatic discovery is available, a list of the cameras found on the customer network 40 may be provided, as illustrated in FIG. 6. These listed cameras may then be individually selected by the operator 16 for viewing of their video and/or still images being transmitted in real-time.

Selecting the focus icon 62 may open a display window for video and/or still images streaming from one or more of the cameras 18, as illustrated in FIG. 7. For example, if there is only one camera 18 on the customer network 40, then selecting the focus icon 62 may automatically open the display window showing video and/or still images streaming from that one camera 18. However, if more cameras are connected to the customer network 40, selecting the focus icon 62 may first lead to the list of the cameras 18, as illustrated in FIG. 6, for selection. Then the video and/or still images from that selected camera may be displayed on the display 30 and may be viewed during the step 320 of adjusting focus on the camera. A menu option 66 for screen capture of the video and/or still images being displayed may also be provided in this view, as illustrated in FIG. 7.

Advantageously, the invention described herein allows for a single operator with no advanced knowledge of networking or the camera system's specific network configurations to efficiently focus one or more of the cameras 18. The security bridge device 14 can be simply plugged into the customer network 40, with no operator adjustments of network settings. No rewiring is required at the cameras 18 in order to view the videos or still images therefrom. For cameras with a dome, the operator can advantageously verify the video or still images immediately while still at the camera after the dome is put on. Additionally, the present invention allows the operator to use already-owned hardware, such as a smart phone or other portable electronic devices, to view live video or images from the cameras 18 while adjusting the camera focus.

Embodiments of the invention provide significantly more than the application of an abstract idea using a generic computer. The current invention provides improvements to the field of cameras in general and methods and systems for focusing or otherwise adjusting cameras in particular. Prior art approaches fail to reliably and efficiently adjust cameras as described herein. The current invention uses unique software and hardware technology to more efficiently and successfully adjust cameras. Furthermore, the programmed portable electronic devices 12 and other computer equipment described herein such as the security bridge device 14 are necessary to perform the steps of the invention. It would require too much time for a human to perform all of the steps of the invention manually, especially when several cameras are controlled.

Although the invention has been described with reference to the embodiments illustrated in the attached drawing figures, it is noted that equivalents may be employed and substitutions made herein without departing from the scope of the invention as recited in the claims. Details of the computer programs, software applications, and related hardware, including exemplary screen displays, are illustrated in the drawing figures. However, the specific hardware, software, and screen shots illustrated and described herein may be replaced with other hardware, software, and screen shots without departing from the scope of the invention.

Having thus described various embodiments of the invention, what is claimed as new and desired to be protected by Letters Patent includes the following:

1. A method for remotely viewing and adjusting camera settings, the method comprising the steps of:
physically and communicably connecting a security bridge device to a customer network, wherein the customer network is communicably coupled to one or more cameras, wherein the security bridge device comprises a processor and one or more communication ports; and
receiving on a portable electronic device video or still images from the one or more cameras via the security bridge device, wherein the portable electronic device is configured to wirelessly communicate with the security bridge device; and
viewing the video or still images on a display of the portable electronic device and substantially simultaneously adjusting focus on the one or more cameras based on the video or still images.

2. The method of claim 1, wherein the security bridge device is configured for addressing and configuring the one or more cameras and automatically determining a best path for transmitting the video or still images.

3. The method of claim 1, wherein the security bridge device is configured to auto-negotiate network settings with the customer network to allow communication between the one or more cameras and the portable electronic device.

4. The method of claim 1, further comprising zooming in to a greater pixel level while viewing the video or still images on the display prior to the step of adjusting the focus.

5. The method of claim 1, wherein the portable electronic device is at least one of a mobile phone, a smart phone, a personal digital assistant (PDA), a palmtop computer, a tablet computer, a notebook computer, and laptop computer.

6. The method of claim 1, further comprising the security bridge device establishing a secure tunnel or virtual private network (VPN) connection with a remote server for transmitting the video or still images to the portable electronic device.

7. The method of claim 1, further comprising the steps of capturing and storing a screenshot of the video or still images with the portable electronic device for customer records.

8. The method of claim 1, wherein the one or more communication ports of the security bridge device include at least one of an Ethernet port, dual Ethernet ports for bridging two networks, a Universal Serial Bus (USB) port, a wireless transmitter, a wireless receiver, and a wireless transceiver for transmitting the video or still images to the portable electronic device.

9. The method of claim 1, wherein the adjusting focus step is performed manually by an operator viewing the video or still images on the display of the portable electronic device.

10. A system for remotely viewing video or still images from one or more cameras for real-time feedback on focus adjustments made by an operator, the system comprising:
a security bridge device configured to physically and communicably couple to a customer network comprising the one or more cameras and configured for at least one of wireless communication and internet connection; and
a portable electronic device located remotely from the security bridge device and having a display, a user interface, and a processor configured for:
receiving and displaying the video or still images on the display from the one or more cameras transmitted by the security bridge device via the internet or wireless transmission.

11. The system of claim 10, wherein the portable electronic device is further configured for:
digitally zooming in to display a greater pixel level of the video or still images prior to the step of adjusting the focus.

12. The system of claim 10, wherein the security bridge device is configured to at least one of:
auto-negotiate network settings with the customer network to allow communication between the one or more cameras and the portable electronic device,
automatically discover the one or more cameras on the customer network,
automatically address and configure the one or more cameras, and
automatically determine a best path for transmitting the video or still images.

13. The system of claim 10, wherein the security bridge device is configured to automatically establish a secure tunnel or virtual private network (VPN) connection with a remote server for transmitting the video or still images to the portable electronic device if the central server has internet connectivity.

14. The system of claim 10, wherein the security bridge device comprises one or more communication ports, including dual Ethernet ports configured for communicably coupling the security bridge device to the customer network and bridging two networks when needed, and a Universal Serial Bus (USB) port for insertion of an internet-connected device if the customer network does not include internet connectivity.

15. A security bridge device allowing remote access to video or still images from one or more cameras on a portable electronic device, the security bridge device comprising:
a port or plug configured to physically and communicably couple with a customer network comprising the one or more cameras;
a processor communicably coupled to the at least one plug or port; and
a non-transitory computer-readable medium communicably coupled with the processor and having a computer program stored thereon that is executable by the processor, the computer program comprising:
a code segment for auto-negotiating network settings with the customer network to allow communication between the one or more cameras and the portable electronic device,
a code segment for basic addressing and configuration of the one or more cameras;
a code segment for automatically determining a best path for transmitting the video or still images, and
a code segment for transmitting the video or still images from the one or more cameras to the portable electronic device or an internet-accessible database via the internet or wireless transmission, based on the determined best path.

16. The security bridge device of claim 15, wherein the computer program further comprises:
a code segment for digitally zooming in onto the video or still images, displaying a greater pixel level of the video or still images.

17. The security bridge device of claim 15, wherein the computer program further comprises a code segment for automatically establishing a secure tunnel or virtual private network (VPN) connection with a remote server for transmitting the video or still images to the portable electronic device if the central server has internet connectivity.

18. The security bridge device of claim 15, wherein the plug or port is a first Ethernet port, the security bridge device further comprising a second Ethernet port for bridging two networks and a Universal Serial Bus (USB) port for insertion of an internet-connected device if the customer network does not include internet connectivity.

19. The security bridge device of claim 15, the code segment for basic addressing further comprises a code segment for automatically discovering the one or more cameras on the customer network or automatically assigning Internet Protocol (IP) addresses to any of the one or more cameras if the customer network does not have Dynamic Host Configuration Protocol (DHCP).

20. The security bridge device of claim 15, wherein the port or plug is configured for Power over Ethernet (PoE) to power components of the security bridge device.
